(19) United States
(12) Patent Application Publication
(10) Pub. No.: US 2009/0230888 A1
(43) Pub. Date: Sep. 17, 2009

(54) DISCHARGE LAMP OPERATION DEVICE

(75) Inventors: Toshitaka Fujii, Hyogo (JP); Atsuji Nakagawa, Hyogo (JP)

Correspondence Address: LUCAS & MERCANTI, LLP, 475 PARK AVENUE SOUTH, 15TH FLOOR, NEW YORK, NY, 10016, US

(73) Assignee: PHOENIX ELECTRIC CO., LTD., Hyogo (JP)

(21) Appl. No.: 12/280,897

(22) PCT Filed: Mar. 20, 2007
(86) PCT No.: PCT/JP2007/055707

§ 371 Date: Aug. 27, 2008

(30) Foreign Application Priority Data
Mar. 22, 2006 (JP) 2006077997

(51) Int. Cl. H05B 41/36

(52) U.S. Cl. 315/307

(57) ABSTRACT

To improve the startability of a discharge lamp by achieving a smooth transition from a glow discharge to an arc discharge. A discharge lamp lighting device comprises: a direct-current power supply 2 for supplying a voltage higher than a glow voltage of the above described discharge lamp; a down-converter 3 for down-converting to an operating voltage of the above described discharge lamp; an arithmetic circuit 4 for detecting an output voltage and output current of the above described down-converter and controlling the current to be supplied to the above described discharge lamp; an oscillator circuit 5; a pulse modulator circuit 6 for varying a duty cycle based on an output of the above described arithmetic circuit at a switching frequency by the above described oscillator circuit to perform switching of the above described down-converter; and a high-voltage generator circuit 7 for generating a high voltage to start the above described discharge lamp, wherein the above described discharge lamp lighting device further comprises an oscillation frequency control circuit 8 which controls the switching frequency of the oscillator circuit to be lower than a predetermined value f_{sw} in a period of transition from a glow discharge phase during a starting operation of the above described discharge lamp to an arc discharge.

### TECHNICAL FIELD

The present invention relates to a discharge lamp lighting device suitable for specific applications such as projection systems.

### BACKGROUND ART

High-pressure discharge lamps (hereinafter may be referred to as a “discharge lamp” or simply as a “lamp”) are being used as various light sources such as light sources for projectors and more recently for large screen rear-projection televisions or head lights of automobiles.

FIG. 5 shows an example of the circuit diagram of a conventional high-pressure discharge lamp lighting device. This circuit is a direct-current discharge lamp lighting device suitable for lighting high-pressure discharge lamps, and is made up of a direct-current power supply 102, a down-converter 103, an arithmetic circuit 104, an oscillator circuit 105, a pulse modulator circuit 106, and a high-voltage generator circuit 107.

Moreover, this circuit is intended to average a square wave generated through an on-off operation of a switching element Q1 by means of an LC filter, and is called a “step-down switching regulator circuit” since it has a characteristic that the output voltage thereof becomes lower than input voltage E.

In FIG. 5, the down-converter 103, which is made up of a switching element Q1, a commutating diode D1, a choke coil L1, and a smoothing capacitor C1, down-converts the voltage of the direct-current power supply 102 to the operating voltage of the discharge lamp 101.

Being input with the output voltage Vₒ of the down-converter 103 and the output current Iₒ flowing through a resistor Rₒ, the arithmetic circuit 104 performs arithmetic operation generally in a “constant-current operation” at start-up of the discharge lamp, and in a “constant-power operation” during a stable lighting operation of the discharge lamp.

The pulse modulator circuit 106 performs the switching of the down-converter 103 by varying the duty cycle at the switching frequency f_{sw}, which is determined by the arithmetic circuit 104 and the oscillator circuit 105, based on the output of the arithmetic circuit 104.

The high-voltage generator circuit 107 generates a high voltage upon activation of the discharge lamp to cause a dielectric breakdown of the discharge lamp thereby lighting the discharge lamp 101.

In FIG. 5, symbol E denotes an input voltage, V_{ds} the drain-source voltage of the switching element Q1 (FET), V_{L} the voltage across the choke coil L₁, Vₒ the output voltage of the down-converter 103, Iₛ the source current of the switching element Q1, I_{d} the current of the commutating diode D₁, I_{L} the current flowing through the choke coil L₁, and Iₒ the output current of the down-converter 103, respectively.

The current I_{L} flowing through the choke coil may take continuous values (this is called as a “continuous mode”) or discontinuous values (this is called as a “discontinuous mode”). Out of these, the output voltage in the continuous mode can be represented as Equation (1) by using a time period Tₒₙ in which the switching element is in an on-state and a time period T_{off} in which that is in an off-state.

Vₒ=E×Tₒₙ/(Tₒₙ+T_{off}) Equation (1)

A condition to go into a continuous mode may be represented as in Equation (2).

Iₒ>(Vₒ/2L)×T_{off} Equation (2)

When adopting a switching regulator circuit to a discharge lamp lighting device, it is designed to be in a continuous mode during a “stable lighting operation” of the discharge lamp 101 from the necessity to stabilize the arc. To be specific, it is considered to be desirable that the inductance of the choke coil is increased as well as the switching frequency is increased (that is, T_{off} is decreased) (see Equation 2). This is because, in this way, since the ripple current flowing through the choke coil L₁ becomes sufficiently small with respect to the lamp load current Iₒ during a stable lighting operation of the discharge lamp 101, the current I_{L} of the choke coil L1 will come into a continuous mode thereby stabilizing the operation of the discharge lamp 101. On the contrary, when the ripple current is large, the arc tends to become unstable due to acoustic resonance phenomena of the discharge lamp 101.

As so far described, conventionally emphasis has been on stabilizing the lighting operation of the discharge lamp; however, emphasis of development has recently being shifted to improving the stability during a starting operation of a lamp.

Moreover, there has been proposed a method to change the switching frequency between during a starting operation and during a stable lighting operation of a lamp in a scheme utilizing an LC resonant circuit (which is different from the scheme of a step-down switching regulator), in order to provide a discharge lamp lighting device in which the fluctuation of the lamp power is small with respect to that of the lamp voltage, and the variation of startup pulse voltage is small (patent document 1). Besides, the following references are known as the background art of the present invention (patent documents 2 to 4).

[Patent document 1] Japanese Patent Laid-Open No. 2004-55512

[Patent document 2] Japanese Patent Laid-Open No. 2005-32711

[Patent document 3] Japanese Patent Laid-Open No. 08-78175

[Patent document 4] Japanese Patent Laid-Open No. 04-349396

### DISCLOSURE OF THE INVENTION

A discharge lamp must be conditioned such that the arc is stabilized during a stable lighting operation, and on the other hand, it is also necessary to achieve a smooth transition from a glow discharge to an arc discharge during a starting operation.

What are required for a smooth transition from a glow discharge to an arc discharge during a starting operation of a discharge lamp are both providing a voltage higher than the glow voltage to the discharge lamp, and providing a sufficient lamp load current. Though the glow voltage (discharge starting voltage) varies depending on the temperature inside the lamp (precisely the temperature at cathode), it is generally high in the case of a hot start (that is, starting from a state in which not much time has passed since the last shut off, and the internal temperature of the discharge lamp is high), and conversely low in the case of a cold start (that is, starting from a state in which the internal temperature of the discharge lamp is low).

In either cases, in conventional circuits, a decrease in the voltage of the direct-current power supply 102 of the input side may lead to an associated decrease in the output voltage Vₒ causing a starting failure. Particularly, when a relatively simple power supply circuit, which is configured to rectify a domestic AC power supply (an AC power supply of a commercial frequency) by means of a voltage multiplying rectifier circuit, is utilized as the direct-current power supply 102, the voltage fluctuation of the commercial AC power supply tends to affect the output voltage Vₒ thereby causing starting failures.

In this regard, when a power supply circuit including a power factor improving circuit (hereinafter, referred to as a “PFC power supply circuit”) is used, the output voltage is relatively high, for example, about 350 [V] and therefore it is unlikely to cause the problem that the power supply voltage is decreased degrading the startability of the lamp.

FIG. 7 shows the relationship between the lamp current flowing through a discharge lamp having an output power of 150 W, and the voltage to be applied to the discharge lamp in the conventional lighting circuit shown in FIG. 5, as well as the output characteristics of the discharge lamp. It is seen that the 0.001 [A] to 0.05 [A] region of the lamp current shows a “state of glow discharge,” the 0.05 [A] to 0.15 [A] region a “transition state from a glow discharge to an arc discharge,” and the region not less than 0.15 [A] an “arc discharge.”

Paying attention to the “output of the lighting device” and the “hot-started discharge lamp,” it is seen that the output characteristic of the lighting device is lower than the characteristic of the glow discharge (that is, the graphs intersect in the vicinity of the transition region). For example, it is indicated that in the case of a “hot start”, at 0.08 [A], which is in the transition state from a glow discharge to an arc discharge, at least 178[V] of glow voltage is needed, whereas the “output of the lighting device” at the same current value has been decreased to 160 [V].

This means that the state of a glow discharge is prolonged during a starting operation and a smooth transition to an arc discharge will not be achieved.

FIGS. 6(a) to 6(e) schematically show the waveforms of each part of the down-converter during a starting operation of the lamp (a glow discharge region). Moreover, a direct-current power supply E is a direct current power supply obtained by a voltage multiplying rectifier circuit, and is configured as E=220 [V] assuming a case in which the voltage value becomes a minimum due to the fluctuation of the power supply voltage.

FIG. 6(a) shows the temporal changes in the magnitude (absolute value) of the drain voltage V_{ds} seen from the source. The initial voltage is given as E=220 [V], and the time period T_{off} in which the switching element Q1 is in an off-state is set to be for example 1.3 [μs], and the time period Tₒₙ to be in an on-state is set to be 13 [μs] (a switching frequency f_{sw}=70 [kHz]) by means of the arithmetic circuit 104, the oscillator circuit 105, and the pulse modulator circuit 106.

For the value of this switching frequency f_{sw}=1/T=1/(Tₒₙ+T_{off})=70 [kHz] and the value of below described inductance of the choke coil, an appropriately high switching frequency and an appropriately large inductance are selected so that the ripple current flowing through the choke coil becomes small with respect to the lamp load current of the discharge lamp during a stable lighting operation. This is because, in that way, since the current I_{L} flowing through the choke coil operates as a continuous mode, it is possible to stabilize the operation of the discharge lamp in a stable lighting operation.

In this regard, assuming a hot-started discharge lamp and that that is in a continuous mode, the output voltage Vₒ is determined from the above described Equation (1) as follows:

Vₒ=E×(Tₒₙ/T)=200 [V]

FIG. 6(b) shows the voltage V_{L} between the choke coils.

V_{L}=E−Vₒ−V_{ds} Equation (3)

While the circuit satisfies Equation (3), the voltage V_{L} changes as V_{ds} changes. However, when the switching element Q1 is in an on-state, the magnitude of V_{ds} is small and therefore can be approximated as V_{ds}=0.

The switching element Q1 is in an on-state when lighting is started and, at this time, the commutating diode D1 is in an on-state with the choke coil L1 being applied with −Vₒ [V]. Then, VdS is applied with the voltage (−E [V]) of the direct-current power supply 102, with Q1 coming into an on-state and D1 coming into an off-state in a short time.

FIG. 6(c) shows the source current Iₛ of the switching element Q1 of which waveform becomes generally as shown in the figure based on FIG. 6(b).

FIG. 6(d) shows the current I_{d} flowing through the commutating diode D1, of which waveform becomes generally as shown in the figure based on FIG. 6(b).

FIG. 6(e) shows the current I_{L} of the choke coil.

Since the following equation:

I_{L}=Iₛ+I_{d} Equation (4)

is satisfied, the waveform obtained by superimposing both waveforms based on FIGS. 6(c) and 6(d) becomes generally as shown in the figure.

The voltage V_{L1} applied to the choke coil L1 during a period in which the switching element Q1 is in an on-state is given as E−Vₒ. That is, in a continuous mode,

V_{L1}=E−Vₒ=220−200=20 [V]

where the amount of current change ΔI_{L} is given as:

ΔI_{L}=(E−Vₒ)/L×Tₒₙ Equation (5)

Substituting L=0.7 [mH] and Tₒₙ=13 [μs] into Equation (5), the following is obtained:

ΔI_{L}=0.37 [A]

However, this is a current value on the assumption of a continuous mode.

In particular, immediately after starting a discharge and until the transition state from a glow discharge to an arc discharge (specifically from around 0.001 [A] to 0.15 [A]), the current and voltage are low with respect to the rated output of 150 W of the discharge lamp; that is, they are in a light load condition and, in such a glow discharge state in which output current Iₒ is small, will go into a discontinuous mode (see Equation 2). From the experiments by the present inventors, the measured value of the current I_{L} was Iₒ=0.04 [A].

The present invention has been made in view of the above described circumstances, and its technical object is to achieve a smooth transition from a glow discharge to an arc discharge (improvement of startability) even when the voltage of the direct-current power supply 102 is lowered.

In the transition state from a glow discharge to an arc discharge, the switching frequency of the oscillator circuit is set to be low so that the ripple current flowing through the choke coil in a discontinuous mode will become large and, on the contrary, during a stable lighting operation, the switching frequency of the oscillator circuit is set to be high so that the ripple current flowing through the choke coil in a continuous mode will become small; that is, the switching frequency is controlled depending on the state of the discharge lamp.

The discharge lamp lighting device relating to the present invention is a discharge lamp lighting device made up of a step-down switching power supply circuit for lighting a discharge lamp 1, characterized by comprising: a direct-current power supply 2 for supplying a voltage higher than a glow voltage of the above described discharge lamp; a down-converter 3 for down-converting to an operating voltage of the above described discharge lamp; an arithmetic circuit 4 for detecting an output voltage and output current of the above described down converter and controlling the current to be supplied to the above described discharge lamp; an oscillator circuit 5; a pulse modulating circuit 6 for varying a duty cycle based on an output of the above described arithmetic circuit at a switching frequency by the above described oscillator circuit to perform a switching of the above described down-converter; and a high-voltage generator circuit 7 for generating a high voltage to start the above described discharge lamp, wherein the above described discharge lamp lighting device further comprises an oscillation frequency control circuit 8 which controls the switching frequency of the oscillator circuit to be lower than a predetermined value f_{sw} in a period of transition from a glow discharge phase during a starting operation of the above described discharge lamp to an arc discharge.

Thus, by controlling the switching frequency to be low during the period of a transition from the state of a glow discharge to an arc discharge, it is possible to output a sufficient current to allow a swift transition to an arc discharge. That is, by setting the switching frequency to be sufficiently low in a glow discharge during a starting operation of the discharge lamp and in the transition range from a glow discharge to an arc discharge (that is during a light load period around 0.001 [A] to 0.15 [A]), it is possible to increase the ripple current in a discontinuous mode which flows through the choke coil of the down-converter so that the lamp load current to flow through the discharge lamp is increased. Thereby, it becomes possible to start the lamp even if the voltage of the direct current power supply is low. Although the direct-current power supply 2 provides a voltage higher than the glow voltage, the glow voltage of this type of discharge lamp (arc length of not more than 2 mm) for projectors is determined to be around 140 [V] to 200 [V] hardly depending on the glow current. It is also because the voltage and current characteristics of the transition region from a glow discharge to an arc discharge are almost uniquely determined given the temperature of the cathode side of the discharge lamp.

Unless the direct-current power supply 2 provides a voltage higher than the glow discharge voltage of the discharge lamp 1, the transition from a glow discharge to an arc discharge cannot take place. Therefore, the voltage of the direct-current power supply 2 is desirable to be higher than 200 [V], and desirably not less than 220 [V]. This can be achieved by a simple rectifier circuit scheme even without using a PFC circuit.

According to a preferred embodiment of the present invention, the switching frequency of the oscillator circuit 5 may be controlled to be high by the oscillation frequency control circuit 8 so that the ripple current of the lamp current due to the switching frequency is sufficiently low at start-up and during a stable lighting operation of the above described discharge lamp 1. This is because by controlling the frequency to be high during a stable lighting operation, the ripple current of the lamp current becomes sufficiently low thereby realizing a stable arc discharge.

That is, by controlling such that the switching frequency is set to low during a starting operation, and in turn the switching frequency is set to high at start-up and during a stable lighting operation, it becomes possible not only to enable a stable lamp starting even when the voltage of the direct-current power supply 2 is low, but also to keep the ripple current to be sufficiently low with respect to the lamp load current at start-up and during a stable lighting operation, thereby maintaining stable operation of the discharge lamp.

It is preferable to provide a timer circuit 9 whereby the switching frequency of the oscillator circuit 5 is controlled to be low from the oscillation frequency control circuit 8 for a predetermined time period Tₛₜ starting from the activation of the above described discharge lamp 1.

Moreover, in the discharge lamp lighting device relating to the present invention, the switching frequency f_{sw} in the period from a glow discharge phase during a starting operation of the discharge lamp until the transition to an arc discharge is preferably not more than 40/L (wherein L is the inductance of the choke coil included in the down-converter 3).

According to the present invention, since a larger lamp current than was previously possible can be supplied in the transition state from a glow discharge to an arc discharge even when the input voltage is lowered, it is possible to improve the startability.

### BEST MODE FOR CARRYING OUT THE INVENTION

### Basic Configuration of Circuit

FIG. 1 shows one example of the circuit diagram of the high-pressure discharge lighting device relating to the present invention. This circuit is a direct-current type discharge lamp lighting device suitable for lighting high-pressure discharge lamps, in which a conventional circuit (see FIG. 5) made up of a direct-current power supply 2, a down-converter 3, an arithmetic circuit 4, an oscillator circuit 5 and a pulse modulator circuit 6 and a high-voltage generator circuit 7 is added with an oscillation frequency control circuit 8 for controlling the frequency of the oscillator circuit 5 and a timer 9 for setting a period to cause a transition from a state of glow discharge to an arc discharge.

In FIG. 1, the down-converter 3 is made up of a switching element Q1, a commutating diode D1, a choke coil L1, and a smoothing capacitor C1, and down-converts the voltage of the direct-current power supply 2 to the operating voltage of the discharge lamp 1.

When input with the output voltage Vₒ of the down-converter 3 and the output current Iₒ flowing through a resistor Rₒ, the arithmetic circuit 4 performs arithmetic operation generally in a “constant-current operation” at start-up of the discharge lamp, and generally in a “constant-power operation” during a stable lighting operation of the discharge lamp.

The pulse modulator circuit 6 performs the switching of the down-converter 3 by varying the duty cycle at the switching frequency f_{sw}, which is determined by the arithmetic circuit 4 and the oscillator circuit 5, based on the output of the arithmetic circuit 4.

The high-voltage generator circuit 7 generates a high voltage when activating the discharge lamp to cause a dielectric breakdown of the discharge lamp to light the discharge lamp 1.

The oscillation frequency control circuit 8 is a circuit having a function of controlling the oscillation frequency of the oscillator circuit such that the switching frequency is sufficiently low during a starting operation of a lamp, and the switching frequency is sufficiently high at start-up and during a stable lighting operation.

The timer circuit 9 is a circuit for setting a period to cause a transition from a glow discharge state to an arc discharge, and it is possible to control the switching frequency of the oscillator circuit to be low by the oscillation frequency control circuit 8 until a predetermined constant time period Tₛₜ has elapsed. The magnitude of the set time period Tₛₜ may be, for example, 6 seconds.

In FIG. 1, symbol B denotes an input voltage, V_{ds} the drain-source voltage of the switching element Q1 (FET), V_{L} the voltage across the choke coil L₁, Vₒ the output voltage of the down-converter 3, Iₛ the source current of the switching element Q1, I_{d} the current of the commutating diode D₁, I_{L} the current flowing through the choke coil L₁, and Iₒ the output current of the down-converter 3, respectively.

FIGS. 2(a) to 2(e) show the voltage or current waveforms of each part of the down-converter during a stable lighting operation when a high-pressure mercury vapor lamp of a direct-current lighting type and of a lamp power of 150 W is used in the discharge lamp lighting device shown in FIG. 1.

The operating voltage of discharge lamp 1 during a stable lighting operation: Vₒ=75 [V]

The voltage of the direct-current power supply 2: E=220 [V]

Operation current: Iₒ=2 [A]

Switching frequency: f_{sw}=70 [kHz]

(Period T=Tₒₙ+T_{off}=1/f_{sw}=14.3 [μs])

Supposing that the period in which the switching element Q1 is in an on-state be Tₒₙ and in an off-state be T_{off}, the current of the choke coil during a stable lighting operation can be calculated in a continuous mode; Equation (1) is rearranged to get:

Tₒₙ=(75/220)×14.3=4.9 [μs]

thus being calculated as Tₒₙ=4.9 [μs] and T_{off}=9.4 [μs]

The voltage V_{L} which is applied to the choke coil L₁ during the period Tₒₙ in which the switching element Q1 is in an on-state is given as:

V_{L}=E−Vₒ=220−75=145 [V]

The amount of current change ΔI_{L} in this period is given as follows, by supposing L₁=0.7 [mH].

ΔI_{L}=(E−Vₒ)/L×Tₒₙ=145 [V]/0.7 [mH]×4.9 [μs]=1.01 [A]

In the period T_{off} in which the switching element Q1 is in an off-state, the commutating diode is conducting and the choke coil is applied with −Vₒ. Supposing that L1=0.7 [mH], the amount of current change ΔI_{L} is given as:

ΔI_{L}=Vₒ/L×T_{off}=75[V]/0.7 [mH]×9.4[μs]=1.01 [A]

Since this satisfies the condition of continuous mode, i.e. Equation (2), and therefore coincides with the above described calculation result of ΔI_{L}.

That is, according to this calculation example, it is seen that the amount of current change ΔI_{L} is about ½ of the operating current Iₒ of the lamp load, indicating a stable continuous mode. Typically, ΔI_{L} is desirably not more than ½.

### Operation During Starting

Now, the operation during starting of the discharge lamp according to the present invention will be described.

FIGS. 3(a) to 3(e) show waveforms of each part of the down-converter during a starting operation of the lamp of the discharge lamp lighting device according to the present invention.

During a starting operation, especially in a transition state from a glow discharge to an arc discharge, a sufficiently low switching frequency is applied. This switching frequency is, for example, a half of that during a stable lighting operation as shown below.

f_{sw}=35 [kHz](period T=1/f_{sw}=13.3 [μs])

Supposing that the period in which the switching element Q1 is in an on-state be Tₒₙ, and in an off-state be T_{off}, the following is obtained from Equation 1 (where in this case a continuous mode is assumed).

Tₒₙ=26 [μs],T_{off}=2.6 [μs]

The voltage V_{L} which is applied to the choke coil L1 during the time period Tₒₙ in which the switching element Q1 is in an on-state becomes as low as E−Vₒ=20 [V] (220[V]-200[V]). Assuming a continuous mode, the amount of current change ΔI_{L} in this period is obtained as:

ΔI_{L}=(E−Vₒ)/L×Tₒₙ=20[V]/0.7 [mH]×26 [μs]=0.74 [A]

In reality, with respect to the lamp output (150 W) during a stable lighting operation, both the output current and the output voltage are in a light-load condition during a starting operation, and from the condition of the above described Equation (2), the current of the choke coil is in a discontinuous mode, not in a continuous mode. According to the experiment by the present inventors, a measured value of the current I_{L} was Iₒ=0.08 [A].

### Comparative Examples of Operation During Starting

FIG. 6 shows waveforms of each part of the down-converter for a case in which the switching frequency during a starting operation is the same as that during a stable lighting operation as in the conventional art, that is:

f_{sw}=70 [kHz],period T=1/f_{sw}=14.3 [μs]

Supposing that the period in which the switching element Q1 is in an on-state be Tₒₙ, and in an off-state be T_{off}, the following is obtained from Equation 1 (where in this case a continuous mode is assumed).

Tₒₙ=13 [μs],T_{off}=1.3 [μs]

Supposing that the amount of current change in this period is in a continuous mode,

ΔI_{L}=(E−Vₒ)/L×Tₒₙ=20[V]/0.7 mmH×13 μs=0.37 [A]

and thus it is about half of the above described comparative example.

As so far described, the current of the choke coil during a starting operation is in a discontinuous mode, not in a continuous mode, and an actual value is Iₒ=0.04 [A]. That is, it is seen that it is half of that of the above described comparative example.

In this way, according to an embodiment of the present invention, it is possible to supply twice as much output current in actual measurement level as that was previously possible during a starting operation.

FIG. 4 shows the relationship between the lamp current flowing through the discharge lamp having an output power of 150 W and the voltage applied to the discharge lamp, as well as the output characteristics of the discharge lamp in the discharge lamp lighting device relating to the present invention shown in FIG. 1. The region of the lamp current 0.001 [A] to 0.05 [A] indicates a “glow discharge state,” 0.05 [A] to 0.15 [A] a “transition state from a glow discharge to an arc discharge,” and not less than 0.15 [A] an “arc discharge”.

Paying attention to the “output of the lighting device” and the “hot-started discharge lamp” in FIG. 4, since the output of the lighting device is 0.08 [A] at 200 [V], and the output characteristic of the lighting device exceeds the characteristic of glow discharge (that is, since there is no intersection of graphs in the vicinity of the transition state), it is shown that a glow discharge state is not prolonged during a starting operation and can be smoothly shifted to an arc discharge. For example, in the case of a “hot start,” a glow discharge voltage of at least 178 [V] is needed at 0.08 [A] which indicates a transition state from a glow discharge to an arc discharge, while the “output of the lighting device” at the same current value is maintained at a value not less than that, i.e. at 200 [V].

This means that a glow discharge state is prolonged during a starting operation and the transition to an arc discharge is smoothly achieved.

Further, in the embodiment shown in FIG. 1, the oscillation frequency control circuit is connected with a timer circuit 9. This makes it possible that during the period in which a glow discharge phase during a starting operation of a discharge lamp is shifted to an arc discharge, the switching frequency is appropriately preset so as to be sufficiently low by the timer circuit 9.

During the period in which a glow discharge phase during a starting operation of a discharge lamp is shifted to an arc discharge, the switching frequency f_{sw} is preferably not more than 40/L from the below described reason. The glow voltage of a discharge lamp for this type of projectors is rarely dependent on the glow current, and is determined to be about 200 [V] when it has a high value. On the other hand, the voltage of the direct-current power supply 2 is assumed to be 220 [V] as a minimum condition in view of the AC voltage of the commercial frequency. To enable a shift from a glow discharge to an arc discharge at this condition, a lamp load current of not less than 0.05 [A], desirably not less than 0.08 [A] is needed. It is seen that the values of the above described embodiment according to the present invention have achieved that.

As the ripple current which flows through the chalk coil L1, at least not less than 0.46 [A] will be needed assuming a continuous mode, though operation will be in a discontinuous mode in reality.

ΔI_{L}=(E−Vₒ)/L×Tₒₙ

Rearranging Equation (1) leads to Tₒₙ=(Vₒ/E)×T, and therefore

$$Δ {I}_{L} = ( E - {V}_{o} ) / L \times ( {V}_{o} / E ) \times T \\ = ( E - {V}_{o} ) {V}_{o} / E \times ( 1 / L ) \times ( 1 / {f}_{sw} )$$

### Accordingly,

f_{sw}=(E−Vₒ)Vₒ)/E×(1/ΔI_{L})×(1/L)

Into this equation, substituting E=220 [V], Vₒ=200 [V], ΔI_{L}=0.46 [A], the following is obtained.

f_{sw}=(E−Vₒ)Vₒ/E×(1/ΔI_{L})×(1/L)=40/L

This leads to a condition that the switching frequency f_{sw} be not more than 40/L in order that starting failures will not occur in a transition state from a glow discharge state to an arc discharge.

### INDUSTRIAL APPLICABILITY

The discharge lamp lighting device relating to the present invention has a very high industrial applicability in that even when the voltage of a direct-current power supply is lowered (for example, to as low as 220 [V]), a rapid transition from a glow discharge to an arc discharge can be achieved thereby enabling a stable lamp starting.

### BRIEF DESCRIPTION OF THE DRAWINGS

FIG. 1 shows an example of the circuit diagram of the high-pressure discharge lamp lighting device relating to the present invention;

FIGS. 2(a) to 2(e) show the voltage or current waveforms of each part of the down-converter during a stable lighting operation when a high-pressure mercury vapor lamp of a direct-current lighting type and of a lamp power of 150 W is used in the discharge lamp lighting device shown in FIG. 1;

FIG. 3 shows waveforms of each part of the down-converter during a starting operation of the lamp of the discharge lamp lighting device relating to the present invention;

FIG. 4 shows the relationship between the lamp current flowing through a discharge lamp having an output power of 150 W and the voltage applied to the discharge lamp, as well as the output characteristics of the discharge lamp in the discharge lamp lighting device relating to the present invention shown in FIG. 1;

FIG. 5 shows an example of the circuit diagram of a conventional high-pressure discharge lamp lighting device;

FIGS. 6(a) to 6(e) schematically show the waveforms of each part of the down-converter during a starting operation of the lamp (a glow discharge region); and

FIG. 7 shows the relationship between the lamp current flowing through a discharge lamp having an output of 150 W and the voltage applied to the discharge lamp, as well as the output characteristics of the discharge lamp.

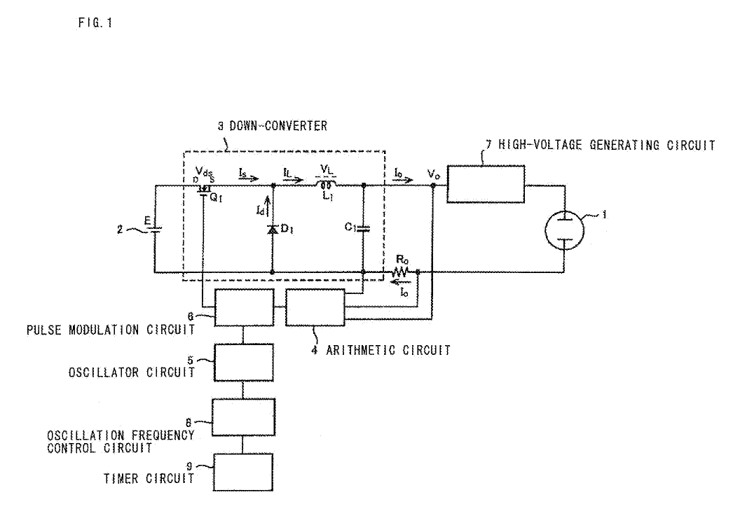

### FIG. 1

### 3 DOWN-CONVERTER

### 4 ARITHMETIC CIRCUIT

### 5 OSCILLATOR CIRCUIT

### 6 PULSE MODULATION CIRCUIT

### 7 HIGH-VOLTAGE GENERATING CIRCUIT

### 8 OSCILLATION FREQUENCY CONTROL CIRCUIT

### 9 TIMER CIRCUIT

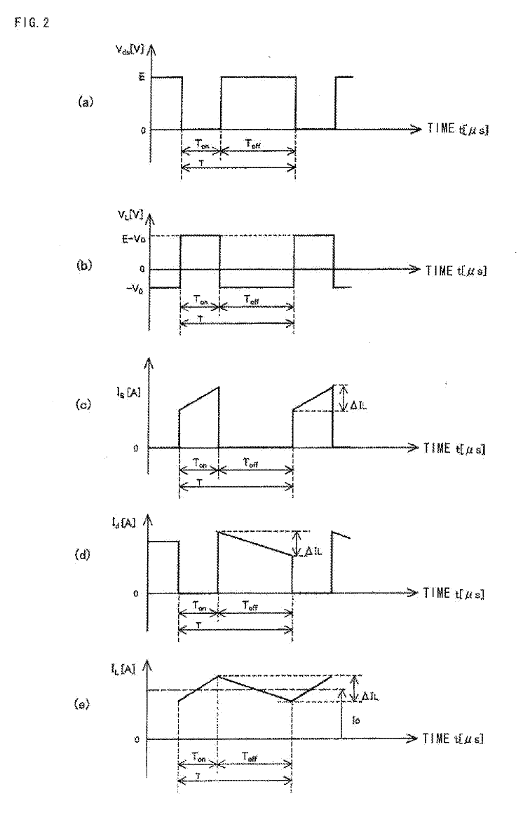

### FIG. 2

### #1 TIME t[μs]

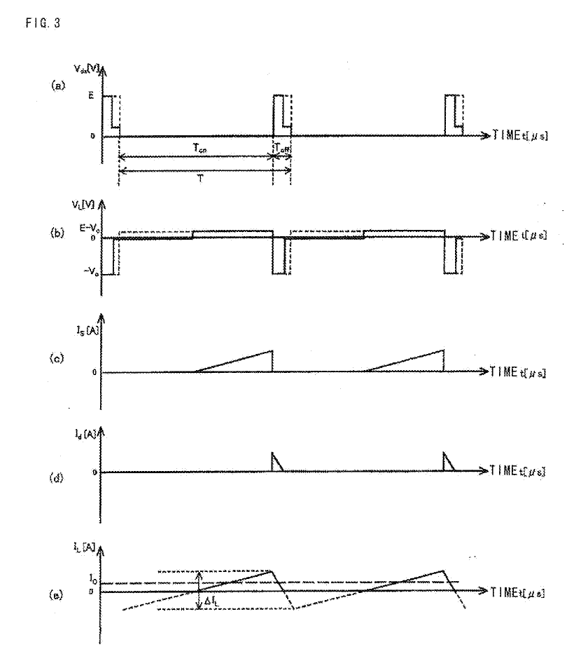

### FIG. 3

### #1 TIME t[μs]

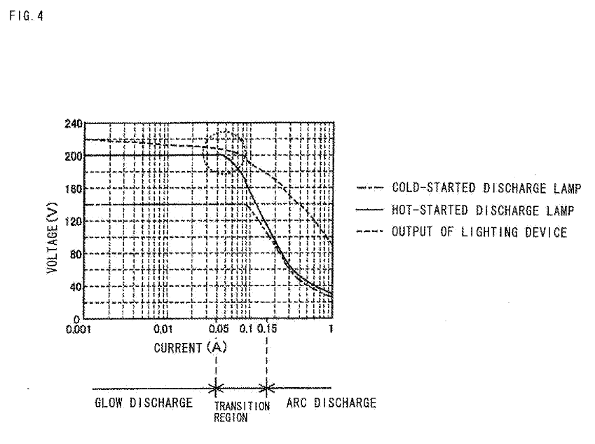

### FIG. 4

### #1 VOLTAGE (V)

### #2 CURRENT (A)

### #3 GLOW DISCHARGE

### #4 TRANSITION REGION

### #5 ARC DISCHARGE

### #6 COLD-STARTED DISCHARGE LAMP

### #7 HOT-STARTED DISCHARGE LAMP

### #8 OUTPUT OF LIGHTING DEVICE

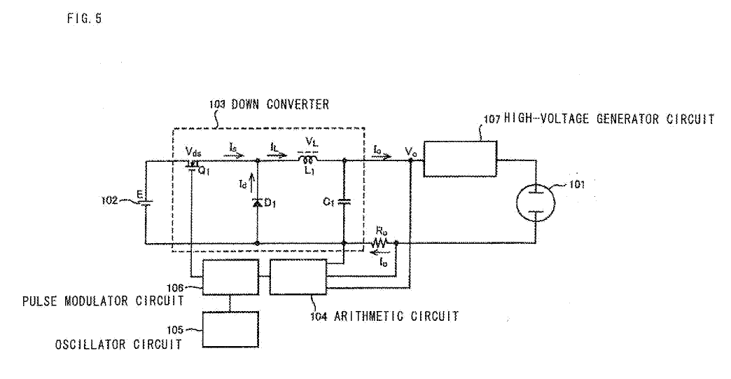

### FIG. 5

### 103 DOWN-CONVERTER

### 104 ARITHMETIC CIRCUIT

### 105 OSCILLATOR CIRCUIT

### 106 PULSE MODULATOR CIRCUIT

### 107 HIGH-VOLTAGE GENERATOR CIRCUIT

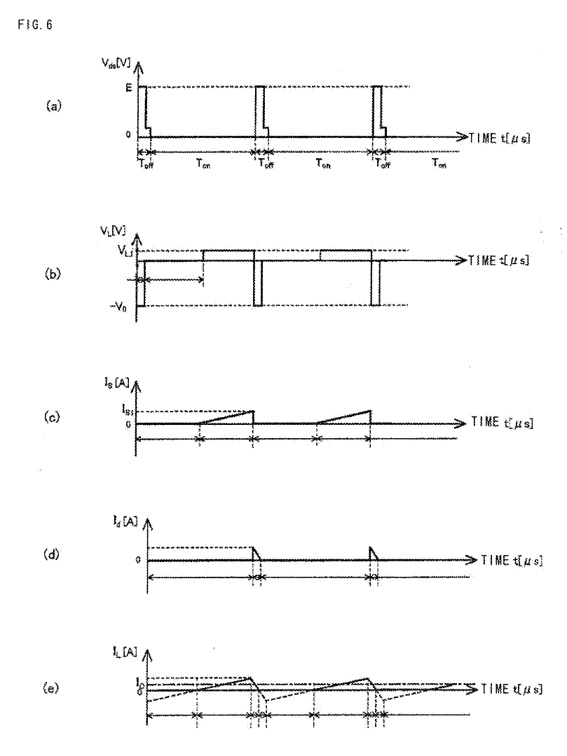

### FIG. 6

### #1 TIME t[μs]

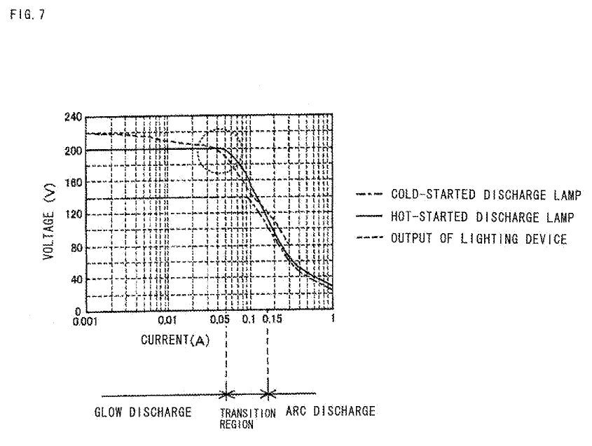

### FIG. 7

### #1 VOLTAGE (V)

### #2 CURRENT (A)

### #3 GLOW DISCHARGE

### #4 TRANSITION REGION

### #5 ARC DISCHARGE

### #6 COLD-STARTED DISCHARGE LAMP

### #7 HOT-STARTED DISCHARGE LAMP

### #8 OUTPUT OF LIGHTING DEVICE

### Description of Symbols

Iₒ Output current (lamp current)
Vₒ Output voltage (lamp voltage)
1, 101 Discharge lamp
2, 102 Direct-current power supply

### 3, 103 Down-converter

4, 104 Arithmetic circuit
5, 105 Oscillator circuit
6, 106 Pulse modulator circuit
7, 107 High-voltage generator circuit
8 Oscillation frequency control circuit
9 Timer circuit

1. A discharge lamp lighting device including a step-down switching power supply circuit for lighting a discharge lamp (1), characterized by comprising:
a direct-current power supply (2) for supplying a voltage higher than a glow voltage of said discharge lamp;
a down-converter (3) for down-converting to an operating voltage of said discharge lamp;
an arithmetic circuit (4) for detecting an output voltage and output current of said down-converter and controlling the current to be supplied to said discharge lamp;
an oscillator circuit (5);
a pulse modulator circuit (6) for varying a duty cycle based on an output of said arithmetic circuit at a switching frequency by said oscillator circuit to perform switching of said down-converter; and
a high-voltage generator circuit (7) for generating a high voltage to start said discharge lamp, wherein
said discharge lamp lighting device further comprises an oscillation frequency control circuit (8) which controls the switching frequency of the oscillator circuit to be lower than a predetermined value f_{sw} in a period of transition from a glow discharge phase during a starting operation of said discharge lamp to an arc discharge.

2. The discharge lamp lighting device according to claim 1, characterized in that said oscillator frequency control circuit (8) is adapted to control said switching frequency of said oscillator circuit (5) to be higher than a predetermined value f_{sw} at start-up and during a stable lighting operation of said discharge lamp (1).

3. The discharge lamp lighting device according to claim 1 or 2, characterized by further comprising a timer circuit (9) so that said oscillator frequency control circuit (8) controls said switching frequency of said oscillator circuit (5) to be lower than a predetermined value f_{sw} for a period Tₛₜ from activation of said discharge lamp (1).
